(19) United States
(12) Patent Application Publication
(10) Pub. No.: US 2009/0291368 A1
(43) Pub. Date: Nov. 26, 2009

(54) Carbon Foam Based Three-Dimensional Batteries and Methods

(76) Inventors: Aron Newman, Cambridge, MA (US); Kevin White, Hudson, MA (US); Quinn Horn, Cambridge, MA (US); Christopher Lang, Haverhill, MA (US)

Correspondence Address: PROSKAUER ROSE LLP, ONE INTERNATIONAL PLACE, BOSTON, MA, 02110, US

(21) Appl. No.: 12/193,482

(22) Filed: Aug. 18, 2008

Related U.S. Application Data
(60) Provisional application No. 60/956,608, filed on Aug. 17, 2007.

(51) Int. Cl. H01M 4/29

(52) U.S. Cl. 429/245; 205/50

(57) ABSTRACT

A three-dimensional battery can include a three-dimensional porous carbon foam base and an anode current collector bonded to and in electrical communication with a first region of the base. The three-dimensional battery can also include an electrolyte layer disposed over the three-dimensional porous carbon foam base and a cathode current collector bonded to and in electrical communication with a second region of the three-dimensional porous carbon foam base.

### CROSS-REFERENCE TO RELATED APPLICATION

This application claims the benefit of and priority to U.S. Provisional Patent Application No. 60/956,608 filed on Aug. 17, 2007, which is owned by the assignee of the instant application and the disclosure of which is incorporated herein by reference in its entirety.

### STATEMENT OF GOVERNMENT INTEREST

The subject matter described herein was developed in connection with funding provided by the Office of Naval Research, Prime Contract ID N00014-06-C-0192. The federal government may have rights in the technology.

### FIELD OF THE INVENTION

The invention generally relates to a three-dimensional battery. Specifically, the invention relates to carbon foam based three-dimensional batteries and methods of making carbon foam based three-dimensional batteries.

### BACKGROUND OF THE INVENTION

Lithium ion batteries are based on shuttling lithium ions between the negative and positive electrode insertion materials. The conventional electrode arrangement is a parallel plate configuration (e.g., a two-dimensional system). As part of the choices in lithium ion cell design, there is typically an engineering trade between energy density and power. As electrodes are made thinner for improved power, more separator and current collector area are required, resulting in a decrease in energy density. The engineering trade exists between capacity and high rate capability.

Simultaneous improvement in form factor flexibility, specific energy and energy density, and specific power and power density tend to be mutually exclusive for batteries with conventional two-dimensional, planar electrode configurations. For example, the form factor of a lithium-ion battery can be made more flexible by replacing the liquid electrolyte phase with a solid polymer electrolyte (SPE). However, the specific power of the system can suffer greatly due to the lower conductivity of SPE's compared to liquid electrolytes. The specific power can be increased by using thinner electrodes and reducing diffusion distances, but the specific energy of the system can decrease due to the increased fraction of current collector and separator components.

### SUMMARY OF THE INVENTION

The invention, in one embodiment, features a battery including a three-dimensional foam base. The three dimensional battery includes an interpenetrating network of anode and cathode separated by an electrolytic layer that allows the transport of ions between the anode and cathode. The interpenetrating network provides increased surface area, which can improve the efficiency and performance characteristics of the battery.

A three-dimensional architecture can achieve a simultaneous improvement in the form factor flexibility, specific energy, and specific power of the battery. Diffusion distances between the anode and cathode can be reduced without sacrificing capacity. In some embodiments, a three-dimensional battery can include a separator that is thin enough to allow for short diffusion distances, and can be pin-hole free. Three-dimensional batteries can provide high power without sacrificing energy density due to the short diffusion distances resulting from the large interfacial area between the electrodes. The three-dimensional battery can provide electrical contact from all or substantially all locations of the electrode (e.g., anode or cathode) to the current collector (e.g., anode current collector or cathode current collector).

In one aspect, the invention features a three-dimensional battery that includes a three-dimensional porous carbon foam base and an anode current collector bonded to and in electrical communication with a first region of the base. The three-dimensional battery also includes an electrolyte layer disposed over the three-dimensional porous carbon foam base and a cathode current collector bonded to and in electrical communication with a second region of the three-dimensional porous carbon foam base.

In another aspect, the invention features a method of making a three-dimensional battery. The method includes attaching an anode current collector to a region of a three-dimensional porous carbon foam base and immersing the three-dimensional porous carbon foam base in an electrolyte to form an electrolyte layer over the three-dimensional porous carbon foam base. The method also includes forming a layer of polyphenyl oxide formed over the electrolyte layer using an electropolymerization process, infiltrating the three-dimensional porous carbon foam base with a carbon slurry and attaching a cathode current collector to a second region of the three-dimensional porous carbon foam base.

In yet another aspect, the invention features a method of making a three-dimensional battery. The method includes forming a three-dimensional base from a porous carbon foam having a predetermined geometric structure, bonding an anode current collector to a region of the three-dimensional base, forming a thin film layer of an electrolyte over the three-dimensional base and forming a layer of polyphenyl oxide formed over the electrolyte layer. The three-dimensional base is infiltrated with a carbon slurry. The method also includes bonding the cathode current collector to a second region of the three-dimensional base.

In another aspect the invention features a three-dimensional battery that includes a three-dimensional porous anode foam base and an anode current collector bonded to and in electrical communication with a first region of the base. The three-dimensional battery also includes a separator layer disposed over the three-dimensional porous anode foam base and a cathode current collector bonded to and in electrical communication with a second region of the three-dimensional porous anode foam base.

In other examples, any of the aspects above, or any apparatus or method described herein, can include one or more of the following features.

In some embodiments, a three dimensional battery can include a gravimetric energy of about 150 Wh/kg to about 200 Wh/kg at a 10 C discharge rate. A three-dimensional battery can include a porous anode foam base that includes at least one of carbon, graphite, metallic lithium, a lithium alloy, aluminum, indium, tin, antimony, lead, silicon, lithium nitride, Li2.6Cu0.4N, Li4.4Si, or lithium titanate.

A three-dimensional porous carbon foam base can include Grafoam FRA-15. In some embodiments, the three-dimensional porous carbon foam base has a porosity of about 80% or about 96%. In some embodiments, the three-dimensional porous carbon foam base has a porosity of range of about 98.6% to about 61%. The three-dimensional porous carbon foam base can include a pore size of about 50 μm with a range from about 1 μm to about 100 μm. In some embodiments, the three-dimensional porous carbon foam base can include a cell size from about 5 μm to about 5000 μm.

The three-dimensional porous carbon foam base can have a density of about 0.24 g/cm³. The three-dimensional porous carbon foam base can have a density in a range of about 0.03 g/cm³ to about 0.6 g/cm³. In some embodiments, the three-dimensional porous carbon foam base has a compressive strength of about 2300 psi, a resistivity of about 1.4×10⁻³ ohms/cm, a Li+ capacity of about 160 mAh/g, or any combination thereof. In some embodiments, the three-dimensional porous carbon foam base has a compressive strength in a range of about 0.2 MPa to about 60 MPa.

In some embodiments, a three dimensional battery includes a layer of polyphenyl oxide formed over the electrolyte layer. The layer of polyphenyl oxide can have a layer thickness of about 200 nm. In some embodiments, the layer of polyphenyl oxide can be about 20 nm.

An anode current collector of a three-dimensional battery can be in electrical communication with the three-dimensional porous carbon foam base (e.g., the carbon foam). A three-dimensional battery can also include a cathode layer disposed over the electrolyte layer. In some embodiments, the cathode layer includes about 90 wt % LiCoO₂ nanoparticles, about 5 wt % aqueous binder and about 5 wt % carbon black. In some embodiments, the cathode current collector of the three-dimensional battery is in electrical communication with the cathode layer.

In some embodiments, a method for making a three-dimensional battery includes infiltrating a three-dimensional base (e.g., a three-dimensional porous carbon foam base) with a carbon slurry that includes about 90 wt % LiCoO₂ nanoparticles, about 5 wt % aqueous binder and about 5 wt % carbon black. Fluid can be removed from the three-dimensional base (e.g., three-dimensional porous carbon foam base) to form a cathode layer over the polyphenyl oxide layer.

The step of attaching the cathode current collector to the second region of the three-dimensional porous carbon foam base can include forming an electrically conductive path between the cathode current collector and the cathode layer. In some embodiments, the step of attaching an anode current collector to the region of the three-dimensional porous carbon foam base includes forming an electrically conductive path between the anode current collector and the three-dimensional porous carbon foam base (e.g., the porous carbon foam). The method of making a three-dimensional battery can also include applying 60 second pulses of about 1.1 Volts to about 2.3 Volts vs. Ag/AgCl to form a layer of polyphenyl oxide.

In some embodiments, bonding the cathode current collector to the second region of the three-dimensional base includes forming an electrically conductive path between the cathode current collector and the cathode layer. Bonding the anode current collector to the region of the three-dimensional base can include forming an electrically conductive path between the anode current collector and the porous carbon foam of the three-dimensional base.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic of a carbon foam based three-dimensional battery cell, according to an illustrative embodiment of the invention.

FIG. 2A shows porous carbon foam for a three-dimensional battery, according to an illustrative embodiment of the invention.

FIG. 2B shows a magnified view of the porous carbon foam of FIG. 2A.

FIG. 3 shows a carbon foam based three-dimensional battery, according to an illustrative embodiment of the invention.

FIG. 4 shows a comparison between discharge rates for different volumes.

FIG. 5 shows a process for manufacturing a three-dimensional battery, according to an illustrative embodiment of the invention.

FIG. 6 shows infiltrating carbon slurry by electrophoretic deposition, according to an illustrative embodiment of the invention.

FIG. 7A shows infiltrated carbon slurry in a three-dimensional battery, according to an illustrative embodiment of the invention.

FIG. 7B is a representation of the infiltrated carbon slurry of FIG. 7A.

FIG. 8A shows a cathode current collector, anode current collector and infiltrated carbon slurry of a three-dimensional battery, according to an illustrative embodiment of the invention.

FIG. 8B is a representation of the cathode current collector, anode current collector and infiltrated carbon slurry of a three-dimensional battery of FIG. 8A.

FIG. 9 is a graph showing a cycle capacity of a three-dimensional battery.

FIG. 10 is a graph showing a discharge curve for a three-dimensional battery.

FIG. 11 shows an electrochemical function of a three-dimensional battery.

FIG. 12 shows a voltage profile of a three-dimensional battery.

FIG. 13 is a Ragone plot showing engineering trade space of capacitors and fuel cells.

### DETAILED DESCRIPTION OF THE INVENTION

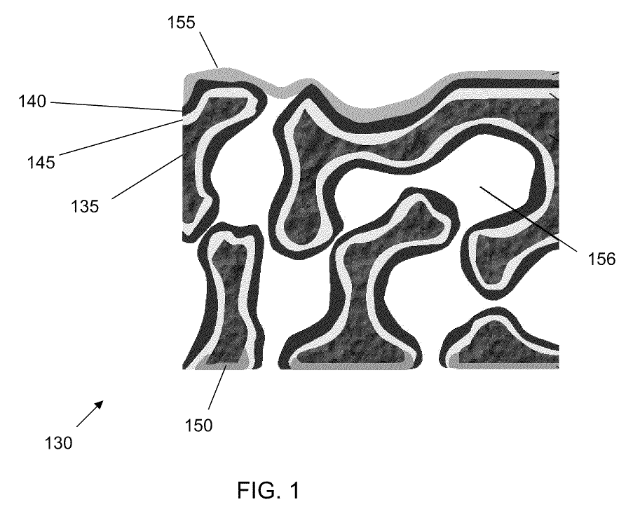

FIG. 1 is a schematic of a carbon foam based three-dimensional battery cell 130, according to an illustrative embodiment of the invention. The three dimensional battery cell 130 includes an anode 135 (e.g., negative electrode), a cathode 140 (e.g., positive electrode), a separator layer 145, an anode current collector 150 (e.g., negative current collector), and a cathode current collector 155 (e.g., positive electrode current collector). Ions are transported between the anode 135 and cathode 140 through the separator layer 145. The anode 135 can include a carbon foam base having pores 156 that allow a separator layer 145 and cathode layer 140 to infiltrate and form on the surface of the anode 135. As a result, the pores 156 allow for a greater surface area as compared to two dimensional batteries. As a result, the pores 156 allow for the anode 135, cathode 140 and separator layer 145 to be formed within a smaller volume. Two orders of magnitude higher interfacial area provides high power without sacrificing capacity. Three-dimensional batteries can have an electrode interfacial area normalized to cell capacity greater than 100 cm²/mAh, and jelly-roll constructed cells can have a value of less than 1 cm²/mAh. In some embodiments, the power density of a carbon foam based three-dimensional battery is about 100 W/kg to about 1000 W/kg. In some embodiments, the energy density of a carbon foam based three-dimensional battery is about 150 Wh/kg to about 200 Wh/kg. In some embodiments, a battery includes two or more interconnected cells 130.

In some embodiments, the anode 135 includes a carbon foam base (e.g., porous carbon foam base) and an anode current collector 150 is bonded to and in electrical communication with a first region of the base. The structure can be designed in various form factors and has the capability of being load bearing. The result is a multifunctional battery providing power and form factor flexibility allowing the battery to be a structural component of the device. A carbon foam based three-dimensional battery can improve discharge capacity, realizing about 50% cathode utilization. The advanced performance of carbon foam based three-dimensional batteries addresses the needs of lightweight torpedoes and is also applicable to various other applications. In some embodiments, a three dimensional battery can include a gravimetric energy of about 150 Wh/kg to about 200 Wh/kg at a 10 C discharge rate. The thickness of the anode 135 can depend on the conductivity of the anode 135 material and of the cathode 140 material. In some embodiments, the anode 135 includes a carbon foam base having a thickness of about 100 μm to about 2 cm. In some embodiments, the anode 135 includes a carbon foam base having a thickness of about 3 mm to about 5 mm.

The carbon foam can be Grafoam FRA-15, manufactured by GraphTech International. The performance of a three-dimensional battery including Grafoam as the carbon foam anode is summarized in Table 1.

TABLE 1
FPA-15 Grafoam Physical Properties

| Property | Value | |
|---|---|---|
| Porosity | 80% | |
| Pore Size | 200 | μm |
| Density | 0.24 | g/cm³ |
| Compressive Strength | 2300 | psi |
| Resistivity | 1.4 × 10 − 3 | Ω/cm |
| Li+ capacity | 160 | mAh/g |

The mechanical support for the Grafoam three-dimensional battery is provided by the foam having a compressive strength of 2300 psi. In some embodiments, the three dimensional battery includes a carbon foam having a compressive strength of about 1 MPa. The three-dimensional porous carbon foam base can include a pore size of about 50 μm or a pore size range from about 1 μm to about 100 μm. In some embodiments, the three-dimensional porous carbon foam base can include a cell size from about 5 μm to about 5000 μm. In this embodiment, the 200 μm pore size is large enough for the addition of the cathode. In some embodiments, the three-dimensional porous carbon foam base has a porosity of about 80% or 95% or a porosity of range of about 98.6% to about 61%. The three-dimensional porous carbon foam base can have a density of about 0.24 g/cm³. In some embodiments, the three-dimensional porous carbon foam base can have a density in the range of about 0.03 g/cm³ to about 0.6 g/cm³. In some embodiments, the three-dimensional porous carbon foam base has a compressive strength of about 2300 psi, a resistivity of about 1.4×10⁻³ ohms/cm or a Li+ capacity of about 160 mAh/g. A more graphitic foam can provide larger capacity, but a factor of five reduction in compressive strength. In some embodiments, the carbon foam has a compressive strength in the range of about 0.2 MPa to about 60 MPa. A three-dimensional carbon foam battery can include a carbon foam from Kfoam available from Koppers, Inc. (Pittsburgh, Pa.) or Pocofoam available from Poco Graphite, Inc. (Decatur, Tex.). A smaller pore size allows for an increased interfacial electrode area, which can result in improved power and energy performance. A higher density foam can allow for increased volumetric energy density (Wh/L).

In some embodiments, the three dimensional cell can include a combination of anodes with the addition of a coating onto a carbon foam before adding the separator layer 145. The anode can be made with a carbon foam or a material that can form a foam structure. In some embodiments, the anode can include carbon, graphite, metallic lithium, a lithium alloy, aluminum, indium, tin, antimony, lead, silicon, lithium nitride, Li2.6Cu0.4N, Li4.4Si, and/or lithium titanate.

In some embodiments, the anode current collector 150 is in electrical communication with the porous carbon foam. In some embodiments, the nickel mesh can be used as an anode current collector 150 which can be attached to the carbon foam acting as the anode 135, the mesh and carbon foam attached with conductive epoxy. The nickel mesh can be 320 mesh. In some embodiments, the anode current collector 150 has a mesh size of about 600 mesh to about 280 mesh. Sputtered copper can be used as an anode current collector 150 that can be attached to the carbon foam anode, the copper and carbon foam attached with conductive epoxy. The anode current collector 1560 can be made of gold and/or nickel.

The separator layer 145 can include a layer of polyphenyl oxide (PPO) having a layer thickness of about 200 nm deposited on to the anode 135 (e.g., carbon foam). The PPO layer can be functionalized with aliphatics to change the PPO layer's electrochemical characteristics and thickness. In some embodiments, the separator layer 145 includes poly(phenylene diamine). The separator layer 145 can include an electrolyte layer or liquid electrolyte such as organic carbonates with various salts. In some embodiment, the electrolyte is 1M LiPF₆ in 1:1 volume of ethylene carbonate and dimethyl carbonate. In some embodiments, the layer of polyphenyl oxide can be about 20 nm. A separator layer 145 (e.g., poly(phenylene oxide) layer) can cover the carbon foam and can transport lithium between the anode 135 and cathode 140. By infiltrating the pores 156 of the anode 135, the PPO layer covers a greater surface area of the anode 135 (e.g., carbon foam base) than if the anode was not porous. The phenoxide monomer can be electropolymerized onto the carbon substrate by a self-limiting reaction as the conformal film becomes electronically isolating. Ionic pathway can be formed by soaking PPO layer in organic carbonate electrolyte. A large interfacial area and the short diffusion distance provided by a separator layer (e.g., separator layer with a thickness of less than 50 nm) can allow for high rate performance.

In some embodiments, the positive electrode 140 is a cathode layer disposed over the separator 145 layer (e.g., electrolyte layer). The cathode layer can include about 90 wt % LiCoO₂ nanoparticles, about 5 wt % aqueous binder and about 5 wt % carbon black. In some embodiments, a layer of polyphenyl oxide is formed over the electrolyte layer 145. LiCoO2 (lithium cobalt oxide) can be a cathode material. In some embodiments, the cathode layer can include a material that can be formed into nanoparticles. In the case of constructing three dimensional cell, the cathode is made of at least one of lithium cobalt oxide, lithium nickel oxide, lithium manganese oxide, lithium iron phosphate, lithium cobalt phosphate, lithium manganese phosphate, lithium nickel phosphate, vanadium oxide, titanium disulfide, molybdenum disulfide, or any combination thereof.

A cathode current collector 155 can be bonded to and in electrical communication with a second region of the anode 135 (e.g., three-dimensional porous carbon foam base). In some embodiments, the cathode current collector of the three-dimensional battery is in electrical communication with the cathode layer 140. The cathode current collector 140 can be bound to the cathode layer 140 coating separator layer 145 (e.g., coated foam) by epoxy followed by the filling of the anode 135 (e.g., carbon foam) with nanoparticle lithium cobalt oxide (LiCoO₂) using a solvent as a carrier. The epoxy can be a Highly Chemical Resistant Novolac Epoxy Coating, Product #643, available from Epoxy.Com, Dunnellon, Fl.

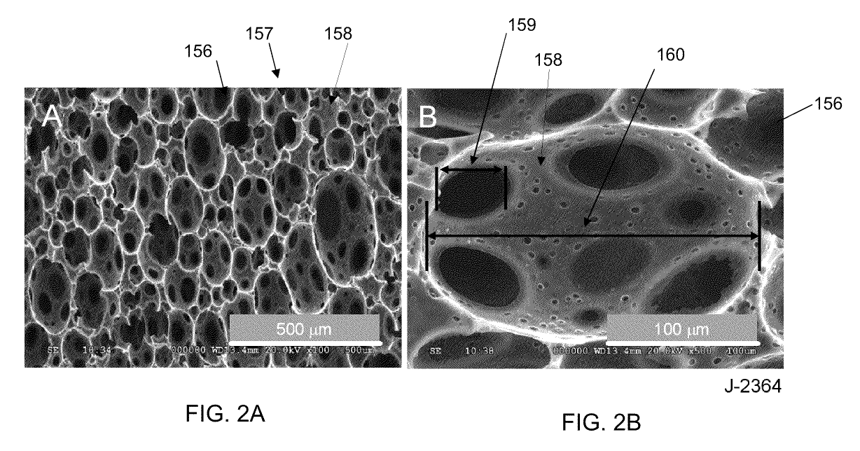

FIGS. 2A and 2B shows porous carbon foam 157 for a three-dimensional battery, according to an illustrative embodiment of the invention. Carbon foam can be a porous body that substantially includes carbon. The carbon foam 157 includes structural element 158 defining pores 156. In some embodiments, a separator layer (e.g., separator layer 145 in FIG. 1) and a cathode (e.g., cathode layer 140 in FIG. 1) are coated and/or formed on to the structural element 158. Such a configuration yields a greater interfacial area for the three-dimensional battery. A separator layer and a cathode layer can be formed over the structural element 158 due to the porous nature of the carbon foam. In some embodiments, pores 156 can have a pore size 159 of about 50 μm with a range from about 1 μm to about 100 μm. In some embodiments, the three-dimensional porous carbon foam base can include a cell size 160 from about 5 μm to about 5000 μm. A three dimensional structural battery with a carbon foam 157 base can address the challenges associated with designing of a three-dimensional battery. The anode in a three-dimensional battery can be the carbon foam 157. Porous carbon foam 157 can provide primary structural support with strengthening provided by a separator layer and cathode.

In addition to the electrochemical performance advantage associated with the three-dimensional battery, the use of a carbon foam 157 as an anode can provide structural support. The pores 156 in the carbon foam 157 form a co-continuous network for the anode and cathode layers formed over the anode that increases the interfacial electrode area. A cathode layer and separator layer can be formed over the carbon foam anode. The pores 156 allow the cathode layer and separator layer to infiltrate the pores and cover a greater surface area of the carbon foam 157. The three-dimensional architecture allows for an improvement in power density while still maintaining the energy density of the cell.

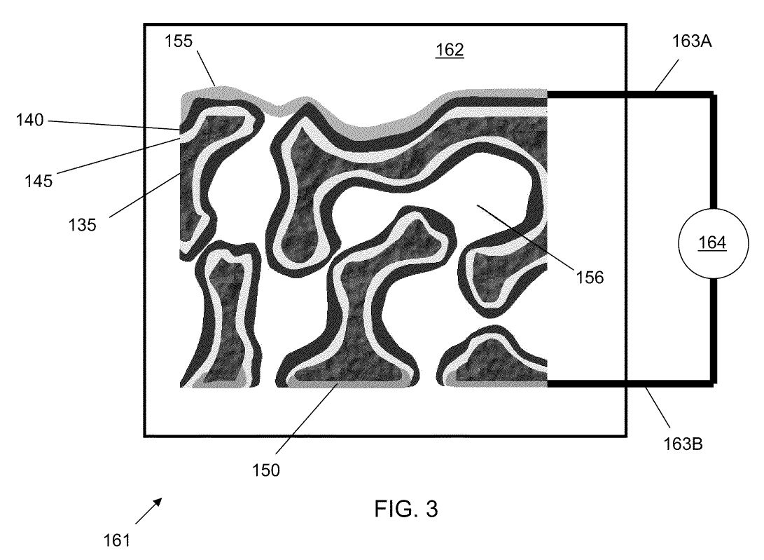

FIG. 3 shows a carbon foam based three-dimensional battery 161 according to an illustrative embodiment of the invention. The three dimensional battery 161 can include a housing 162 having a cell that includes an anode 135 (e.g., carbon foam anode), cathode 140 (e.g., a cathode layer) and a separator layer 145 disposed between the anode 135 and cathode 140. A cathode current collector 155 can be connected to the cathode 140 and an anode current collector 150 can be connected with the anode 135. The cathode current collector 155 and anode current collector 150 can be connectable to a load 164 via leads 163A and 163B.

In a three-dimensional electrode configuration, the diffusion profiles can be radial, rather than planar. The effect that radial diffusion profiles have on the discharge reaction process can be estimated by calculating the relative diffusion distances within the electrode materials. If a linear concentration gradient is assumed, the diffusion distance x (in cm) for Li⁺ in the cathode can be calculated by:

x=2\sqrt{D_{Li+}t} (EQN. 1)

where D_{Li+} is the diffusion coefficient (in cm²/s) of Li⁺, and t is the discharge time (in seconds). Based on this relationship, the volume fraction of discharged cathode material can be calculated as a function of discharge time for both planar and radial diffusion conditions.

Assuming a constant flux of Li⁺ and chemical potential gradient, the volume fraction of a cube discharged in t seconds is found by:

$${f}_{V}^{cube} = \frac{{V}_{R}}{{V}_{cube}} = \frac{2 {a}^{2} \sqrt{{D}_{{Li}^{+}} t}}{{a}^{3}} = \frac{2 \sqrt{{D}_{{Li}^{+}} t}}{a} \qquad ( EQN . 2 )$$

where V_{R} is the volume of the cube reacted in t seconds, V_{cube} is the total volume of the cube and a is the length of the cube edge.

Similarly, for a sphere:

$$\begin{matrix}{f}_{V}^{sphere} = \frac{{V}_{R}}{{V}_{sphere}} \\ = \frac{\frac{4}{3} π ( {r}^{3} - {( r - 2 \sqrt{{D}_{{Li}^{+}} t} )}^{3} )}{\frac{4}{3} π {r}^{3}} \\ = \frac{{r}^{3} - {( r - 2 \sqrt{{D}_{{Li}^{+}} t} )}^{3}}{{r}^{3}}\end{matrix} \qquad ( EQN . 3 )$$

where Vₛₚₕₑᵣₑ is the total volume of the sphere, V_{R} is the volume of the sphere discharged in t seconds and r is the radius of the sphere.

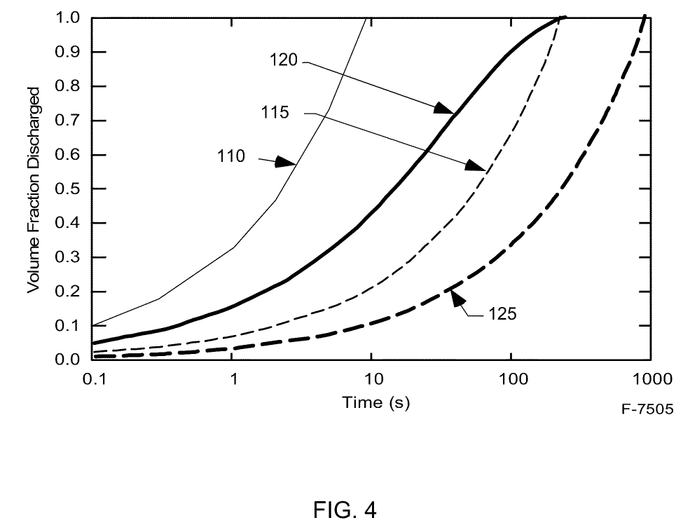

The results of these calculations are shown in which FIG. 4, which shows a comparison between discharge rates for different volumes (e.g., rectangular volume (a/10) 110, rectangular volume (a/2) 115, spherical volume 120 and cubic volume 125). The graph shows the volume fraction discharged in the three-dimensional battery over time. The diffusion coefficient of Li+ (D_{Li+}) was valued at 2.68×10⁻⁸ cm²/s in the porous electrode with a planar electrode thickness of 100 μm, and V_{cube} equal to Vₛₚₕₑᵣₑ. While the diffusion distance of Li⁺ is the same in both the cubic 125 and spherical volumes 120 at a given discharge time, the volume fraction of discharged cathode is larger in the spherical volume 120 due to the radial diffusion profile and the larger surface area exposed to Li⁺ per unit volume of cathode. A rectangular volume (a/10) 110 has an aspect ratio of 10 and a cubic volume 120 has an aspect ratio of 1. The higher aspect ratio will have a higher surface area. A higher surface area results in faster charging and discharging which results in a higher volume fraction at an earlier time.

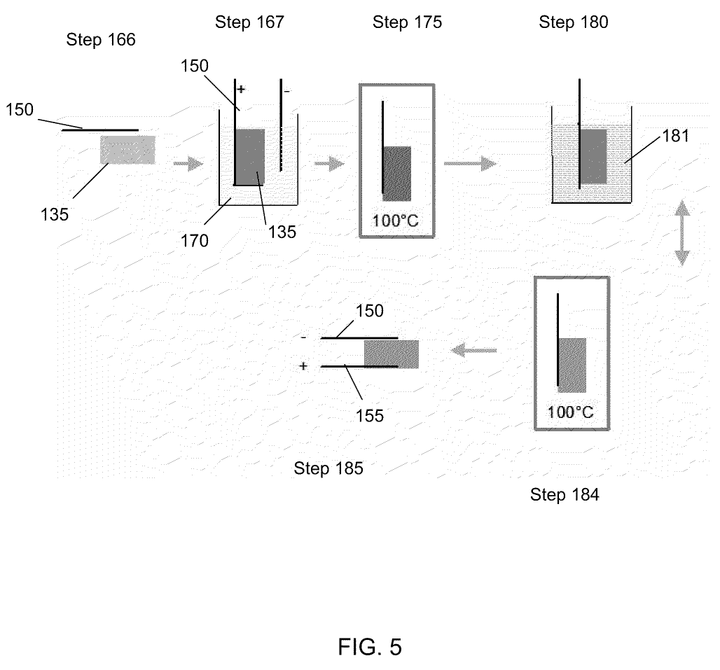

FIG. 5 illustrates a process for manufacturing a three-dimensional battery, according to an illustrative embodiment of the invention. The process can include the step 166 of using a graphite paint adhesive to apply the anode current collector 150 (e.g., Ni mesh or sputtered copper) onto the anode 135 (e.g., carbon foam such as Grafoam FRA-15). A Novolac-based epoxy, which is resistant to organic solvents, can be used to seal the junction between the anode current collector 150 and the anode 135. The anode current collector 150 and carbon foam acting as the anode 135 can be cured overnight.

The process can include the step 167 of placing the assembly in an acetonitrile-based electrolyte 170 containing 0.05 M phenol, 0.05 M tetramethylammonium hydroxide, and 0.1 M tetrabutylammonium percholorate. The phenol can be converted in a phenoxide to form the polymer. In some embodiments, step 167 includes placing the assembly in an acetonitrile-based electrolyte 170 containing 0.05 M sodium phenoxide, 0.05 M tetramethylammonium hydroxide, and 0.1 M tetrabutylammonium percholorate. The acetonitrile can be used as a solvent that is chemically inert to the potentials used for deposition and can be used to dissolve the phenoxide. The process can include applying a voltage of about 1.1 V vs. Ag/AgCl to about 2.3 V vs. Ag/AgCl in 60 second pulses to deposit poly(phenyl oxide) on the carbon. Duration of the pulses and the extent of the pulses can be varied for uniform deposit of the poly(phenyl oxide) on the carbon. This electropolymerization process is self limiting and can result in a film thickness on the order of about 200 nm to about 300 nm. The electropolymerization process can take about four hours. In some embodiments, the film thickness is on the order of approximately about 5 nm to about 20 nm.

In some embodiments, non-aqueous electrolyte solutions include cyclic and acyclic carbonates, acyclic carboxylates, cyclic and acyclic ethers, phosphates, lactone compounds, nitrile compounds, amide compounds, and mixtures thereof. Examples of cyclic carbonates can include alkylene carbonates such as propylene carbonate (PC), ethylene carbonate (EC) and butylenes carbonate. Examples of acyclic carbonates can include dialkyl carbonates such as dimethyl carbonate (DMC), methyl ethyl carbonate (MEC), and diethyl carbonate (DEC). Examples of acyclic carboxylates can include methyl acetate and methyl propionate. Examples of suitable cyclic or acylic ethers include tetrahydrofuran, 1,3-dioxolane, and 1,2-dimethyoxyethane. Examples of phosphates can include trimethyl phosphates include trimethyl phosphate, triethyl phosphate, ethyldimethyl phosphate, diethyl methyl phosphate, ethyldimethyl phosphate, diethyl-methyl phosphate, tripropyl phosphate, tributyl phosphate, tri(trifluoromethyl) phosphate, tri(trichloromethyl) phosphate, tri(trifluormethyl) phosphate, tri(perfluoroethyl)phosphate, 2-ethoxy-1,3,2-dioxaphosphoran-2-one, 2-trifluoroethoxy-1,3,2-dioxaphosphoran-2-one, and 2-methoxyethoxy-1,3,2-dioxaphosphoran-2-one. An example of a lactone compound is gamma-butyrolactone. An example of a nitrile compound is acetonitrile. An example of a suitable amide compound is dimethylformamide. Of these, cyclic carbonates, acyclic carbonates, phosphates and mixtures thereof can elicit high charge and/or discharge characteristics.

In some embodiments, the process includes the step 175 of removing the deposition electrolyte. After the deposition electrolyte is removed, the assembly can be left overnight. The process can include the step 180 of infiltrating cathode slurry 181 into the poly(phenyl oxide) covered carbon foam. In some embodiments, the cathode slurry consists of 90 wt % LiCoO₂ nanoparticles, 5 wt % aqueous binder, and 5 wt % carbon black. Small particles can increase the contact area with the PPO. In some embodiments, the LiCoO₂ nanoparticles are sized from about 30 nm to about 70 nm. In some embodiments, the size of the LiCoO₂ nanoparticles are from about 10 nm to about 300 nm. In some embodiments, the aqueous binder is LHB-108P by Lico Technology Corp. In some embodiments, the cathode slurry includes acetylene black that includes a 2:1 weight ratio of Formula BT LBG-8004 by Superior Graphite Inc. and acetylene black C-55 by Chevron. The suspension medium can be a 50:50 solution of water and isopropanol.

The infiltration process may be repeated to increase cathode solids loading. The effectiveness of the electrophoretic deposition can depend on the solids loading. In some embodiments, the solids loading is about 0.5 wt % to 10 wt %. In some embodiments, the solids loading is about 3 wt %. In some embodiments, the infiltration process can be repeated with a two hour cycle. The two hour cycle can include removing the infiltrated assembly and drying the assembly at about 60° C.

The process for manufacturing a three-dimensional battery can include the step 180 of removing all fluid from the foam assembly (step 184) and bonding (step 185) the cathode current collector 155 (e.g., sputtered aluminum) to another region (e.g., a reverse side, or cathode layer 140) of the carbon foam base using the same process as with the anode current collector. In some embodiments, the cathode current collector can be cured overnight with the assembly (e.g., which can include the anode current collector, carbon foam, separator layer and cathode layer).

A process of making a three-dimensional battery includes attaching an anode current collector 150 to a region of a anode 135 (e.g., three-dimensional porous carbon foam base) (step 162) and immersing the three-dimensional porous carbon foam base in an electrolyte (step 165) to form an electrolyte layer 140 over the anode 135 (e.g., three-dimensional porous carbon foam base). In some embodiments, the step of attaching an anode current collector 150 to the region of the anode 135 includes forming an electrically conductive path between the anode current collector 150 and the anode 135 (e.g., porous carbon foam base).

In some embodiments, the method includes forming a layer of polyphenyl oxide formed over the electrolyte layer 145 using an electropolymerization process. In some embodiments, the process includes applying 60 second pulses of about 1.1 Volts to about 2.3 Volts vs. Ag/AgCl to form a layer of polyphenyl oxide. The anode current collector 150 and anode 135 (e.g., three-dimensional porous carbon foam base) assembly can be removed from the electrolyte (step 175).

The three-dimensional porous carbon foam base is infiltrated with a carbon slurry (step 180). In some embodiments, a process for making a three-dimensional battery includes infiltrating a three-dimensional base (e.g., a three-dimensional porous carbon foam base) with about 90 wt % LiCoO₂ nanoparticles, about 5 wt % aqueous binder and about 5 wt % carbon black. LiCoO2 (lithium cobalt oxide) can be a cathode material. In some embodiments, the cathode layer can include a material that can be formed into nanoparticles. In the case of constructing three dimensional cell, the cathode is made of at least one of lithium cobalt oxide, lithium nickel oxide, lithium manganese oxide, lithium iron phosphate, lithium cobalt phosphate, lithium manganese phosphate, lithium nickel phosphate, vanadium oxide, titanium disulfide, molybdenum disulfide, or any combination thereof. Fluid can be removed (step 184) from the three-dimensional base (e.g., three-dimensional porous carbon foam base) to form a cathode layer 140 over the polyphenyl oxide layer. A cathode current collector is attached to a second region of the three-dimensional porous carbon foam base (step 185). The step of attaching the cathode current collector 155 to the second region of the three-dimensional porous carbon foam base can include forming an electrically conductive path between the cathode current collector 155 and the cathode layer 140.

A process of making a three-dimensional battery can also include forming a three-dimensional base from a porous carbon foam having a predetermined geometric structure and bonding an anode current collector 150 to a region of the three-dimensional base (step 162). Bonding the anode current collector 150 to the region of the three-dimensional base can include forming an electrically conductive path between the anode current collector 150 and the porous carbon foam of the three-dimensional base.

The process can include forming a thin film layer of an electrolyte over the three-dimensional base and forming a layer of polyphenyl oxide formed over the electrolyte layer (step 165). The three-dimensional base is infiltrated with a carbon slurry (step 180). The carbon slurry can include about 90 wt % LiCoO₂ nanoparticles, about 5 wt % aqueous binder and about 5 wt % carbon black. The process also includes bonding the cathode current collector 155 to a second region of the three-dimensional base (step 185). In some embodiments, bonding the cathode current collector 155 to the second region of the three-dimensional base includes forming an electrically conductive path between the cathode current collector 155 and the cathode layer 140.

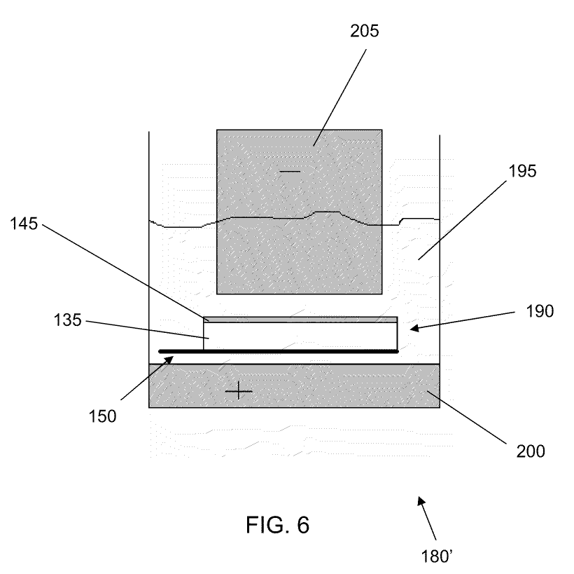

FIG. 6 shows a setup that can be used for infiltrating carbon slurry by electrophoretic deposition. An improved method of filling the PPO coated foam 190 is with electrophoretic deposition with an assembly that includes a bottom electrode 200, top electrode 205, electrophoretic deposition solution 195 and an assembly that includes an anode current collector 150, anode 135 (e.g., porous carbon foam) and separator layer 145. The electrophoretic deposition solution 195 can contain LiCoO₂, conductive carbon, and binder that are well mixed into a isopropanol-water solution. LiCoO₂ nanoparticles from the electrophoretic deposition solution 195 can be infiltrated by depositing the assembly in a solution and applying a potential bias to an electrode 205 coupled with the charge of the particles that provides a force to move the particles towards electrode 200. The particles can travel in the electric field created between electrode 200 and electrode 205, moving towards electrode 200.

The potential of the bottom electrode 200 can be controlled with a potentiostat. The top electrode 205 can function as the counter electrode/reference electrode in the 2-electrode setup. Depending on the ratio of isoproponal to water in the electrophoretic deposition solution 195, voltages for electrophoretic deposition can range from about 8 volts to about 18 volts with high voltages for the isopropanol-rich solutions. A water-isopropanol allows for good suspension and has a high dielectric constant.

In some embodiments, four electrophoretic deposition cycles are carried out with the potential scanned from open circuit voltage (OCV) to the desired end voltage from 25 to 100 mV/s. Initial electrophoretic deposition cycles can be carried out over several days to allow the cathode solvent to completely dry between each cycle in order to record mass gains. This addition method achieves a cathode loading that was a factor of two greater than by drip coating. Following the final deposition, the cell 190 can be allowed to dry and then the aluminum mesh cathode current collector (e.g., cathode current collector 155 as described above in FIGS. 1, 3 and 5 above) can be bonded to the cathode face (e.g., cathode layer 140 as described above in FIGS. 1, 3 and 5 above). Limiting solvent removal during the fabrication procedure expedites processing and reduces component stresses.

The rate of deposition,

$$\frac{d w ( t )}{d t}$$

can depend on several factors, as shown in EQNS. 4-5 below:

$$\begin{matrix}\frac{d w ( t )}{d t} = {w}_{0} k exp ( - kt ) & ( EQN . 4 ) \\ k = \frac{A}{V} \cdot \frac{ɛ ζ}{4 π η} ( E - Δ E ) & ( EQN . 5 )\end{matrix}$$

where w is the wt. of solid particles deposited on electrode, k is the kinetic constant, t is the deposition time, A is the electrode area, V is the slurry volume, wₒ is the starting wt. particles in slurry, ∈ is dielectric constant, z stands for the zeta-potential of the particle in the solvent, η stands for the viscosity of the solvent, E is the applied direct-current voltage and ΔE is the voltage drop across the deposited layer.

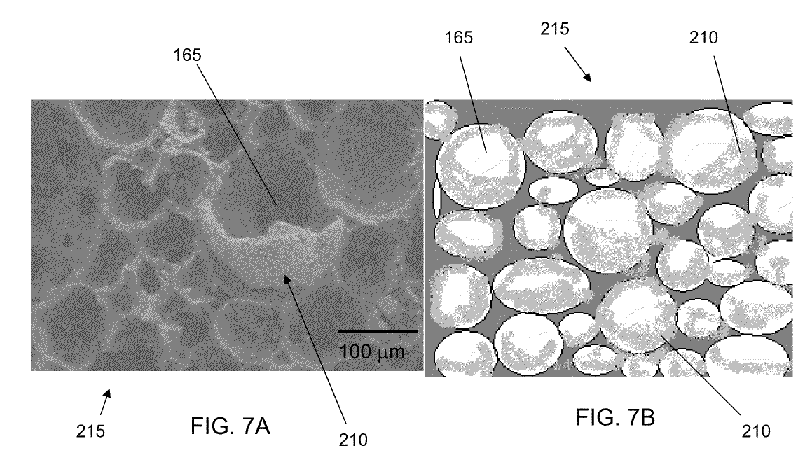

FIG. 7A shows infiltrated carbon slurry 210 in a three-dimensional battery, according to an illustrative embodiment of the invention. FIG. 7B shows a representation of the infiltrated carbon slurry 210 of FIG. 7A. Carbon slurry 210 (e.g., which can include LiCoO₂ nanoparticles) can be deposited in the carbon foam coated with poly(phenyl oxide) 215. The white regions are LiCoO₂ nano particles 210 and the fractured foam 215 shows coverage of LiCoO₂ nanoparticles in smaller and larger pores 165. The LiCoO₂ particles 210 can be self-supporting. Carbon foam 215 pore diameters can range from about 20 μm to about 200 μm. The fractured surface 215 shows the spherical pores 165 of the carbon foam 215 and the coating of nanoparticle LiCoO₂ 210 covering the carbon surface. The nanoparticle 210 coverage can be thick enough to form a self-supporting layer. Region 210 shows a self-supporting LiCoO₂ layer that contributes to the structural integrity of the battery.

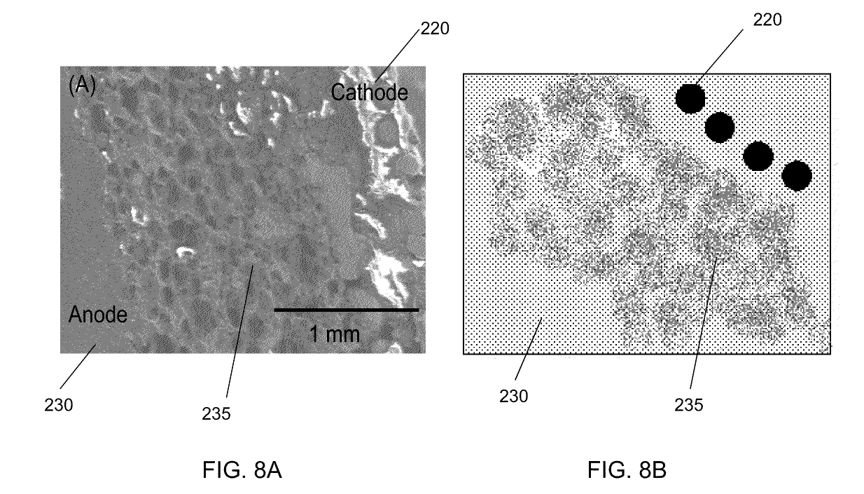

FIG. 8A shows a cathode current collector 220, anode current collector 225 and infiltrated carbon slurry 230 of a three-dimensional battery, according to an illustrative embodiment of the invention. FIG. 8B is a graphical representation of the cathode current collector 220, anode current collector 225 and infiltrated carbon slurry 230 in FIG. 8A. Electrophoretic deposition can be used to infiltrate a carbon slurry 230 (e.g., which can include LiCoO₂) into a carbon foam. The cobalt can infiltrate through the carbon foam from the cathode current collector 220 (e.g., aluminum current collector) to the anode current collector 225. Effective infiltration can improve cell capacity and high rate capability. The circular regions 235 on the cathode side are the cross section of the cathode current collector 220 (e.g., aluminum mesh current collector, nickel mesh current collector, etc.). In some embodiments, infiltration depths are more than doubled to nearly 2 mm by using electrophoretic deposition compared to a drip filling method (e.g., adding the slurry drop wise into the foam structure where capillary action created by the small pores in the foam draws the slurry into the foam.). The level of penetration can nearly reach the anode current collector 225 side of the cell.

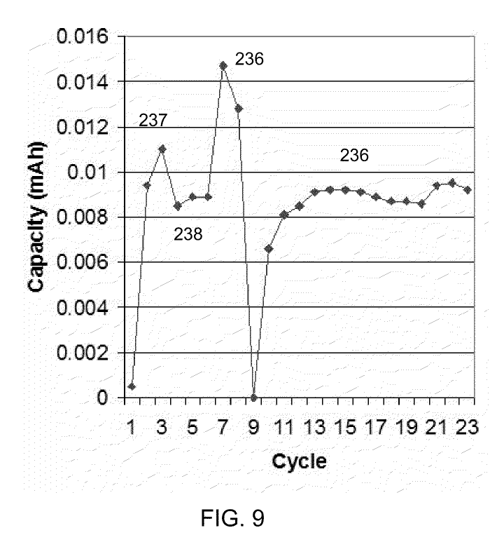

FIG. 9 is a graph showing a cycle capacity of a three-dimensional battery, according to an illustrative embodiment of the invention. Specifically, the graph shows the discharge capacity (mAh) over 23 cycles. The cell was discharged at 50 μA 236, 100 μA 237, and 200 μA 238. The cell capacity at 50 mAh decreases due to increases IR from the poor contact of the current collector. The cell was able to charge and discharge for over 20 cycles.

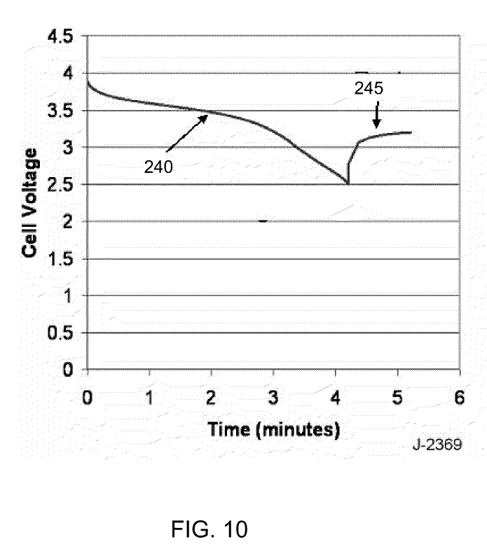

FIG. 10 is a graph showing a discharge curve for a three-dimensional battery, according to an illustrative embodiment of the invention. Specifically, the graph shows cell voltage over time. The three-dimensional battery tested in FIG. 10 was a rectangular volume. The rectangular volumes represent the effect of reduced electrode thickness on the total discharge time. A reduction in the thickness of the electrode can significantly reduce the amount of time it takes to discharge a fixed volume. However, reducing the electrode thickness typically results in reduced specific energy.

FIG. 10 shows a discharge curve 240 at 1 mA. The three-dimensional battery cell can be constructed with a more robust epoxy for bonding the Ni mesh to the cathode. A robust epoxy is an epoxy that has a chemical resistance to the electrolyte, where the epoxy does not swell, deform, or soften). In some embodiments, a novolac based epoxy is used to bond a cathode current collector (e.g., Ni mes) to the cathode. The discharge curve shape is consistent with a typical lithium cobalt oxide versus graphite cell. The rest step 245 indicates there is cell polarization. The cell can be soaked overnight in 1 M LiPF6 1:1 ethylene carbonate (EC):dimethyl carbonate (DMC) electrolyte. LiPF6 can be used as a salt for the electrolyte. In some embodiments, the lithium salt for the liquid electrolyte is made with materials that dissolve into organic carbonate solvents. The lithium salt for the liquid electrolyte can include at least one of lithium tetrafluoroborate, lithium hexafluorophosphate, lithium perchlorate, lithium trifluoromethanesulfonate, sulfonyl imide lithium salts, sulfonyl methide lithium salts, lithium acetate, lithium trifluoroacetate, lithium benzoate, lithium p-toluenesulfonate, lithium nitrate, lithium bromide, lithium iodide, and/or lithium tetraphenylborate.

Electrolyte can provide lithium transport across a PPO separator layer. The cell has a mass of 71 mg without the current collector and a volume of 0.4 cm³. Table 2 below summarizes the battery performance:

TABLE 2
Three-Dimensional Battery Performance

| Parameter | Value | |
|---|---|---|
| Energy Density | 3.3 | mWh/g |
| Power Density | 46 | mW/g |
| Discharge Time | 4 | minutes |
| Discharge Current | 1 | mA |
| C-rate | 15 | C |

In some embodiments, the power density of a carbon foam based three-dimensional battery is about 100 W/kg to about 1000 W/kg. In some embodiments, the energy density of a carbon foam based three-dimensional battery is about 150 Wh/kg to about 200 Wh/kg.

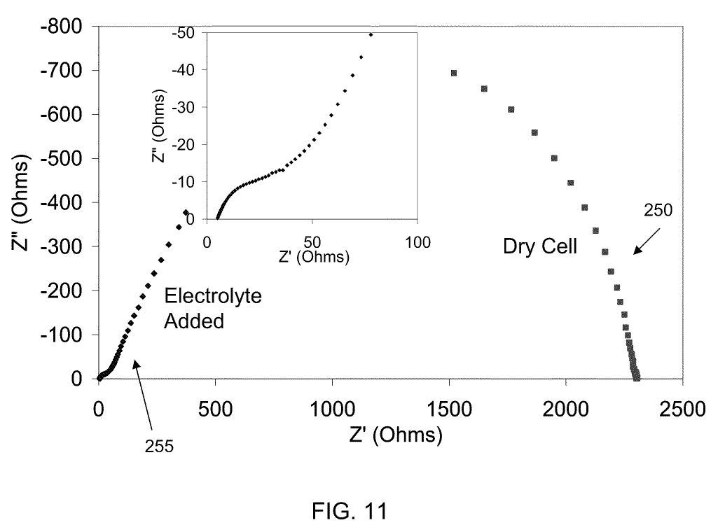

FIG. 11 shows electrochemical function of a three-dimensional battery before adding liquid electrolyte 250 and after adding liquid electrolyte 255. The intercept with the real axis indicates current collector resistance. Intercept resistance can be decreased by improving current collector attachment. As current collector attachment improves, resistance decreases with the intercept resistance at 5 Ohms.

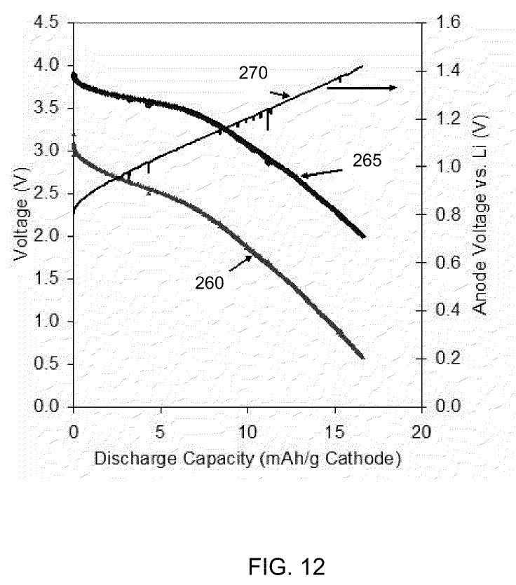

FIG. 12 shows a voltage profile 260 of a three-dimensional battery, according to an illustrative embodiment of the invention. The carbon foam based three-dimensional battery was discharged at 1-C rate. The cathode potential 265 is consistent with LiCoO₂. Cell voltage depressed with high anode potential 270. Increasing the degree of anode lithiation can drop anode voltage and increase cell voltage.

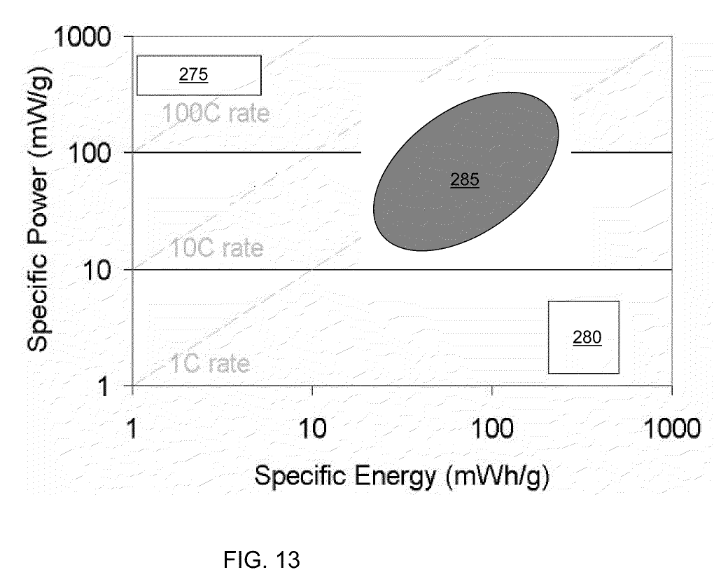

FIG. 13 is a Ragone plot showing engineering trade space of a capacitor 275 and a fuel cell 280. A capacitor 275 has a relatively high specific power, but a low specific energy. In contrast, a fuel cell 280 has high specific energy, but low specific power. A three-dimensional architecture for a battery 285 allows lithium ion to move towards both high energy and high power.

While the invention has been particularly shown and described with reference to specific illustrative embodiments, it should be understood that various changes in form and detail may be made without departing from the spirit and scope of the invention.

1. A three-dimensional battery comprising:
a three-dimensional porous carbon foam base;
an anode current collector bonded to and in electrical communication with a first region of the base;
an electrolyte layer disposed over the three-dimensional porous carbon foam base; and
a cathode current collector bonded to and in electrical communication with a second region of the three-dimensional porous carbon foam base.

2. The battery of claim 1 comprising a gravimetric energy of about 150 Wh/kg to about 200 Wh/kg at a 10 C discharge rate.

3. The battery of claim 1 wherein the three-dimensional porous carbon foam base comprises Grafoam FRA-15.

4. The battery of claim 1 wherein the three-dimensional porous carbon foam base has a porosity of about 80%.

5. The battery of claim 1 wherein the three-dimensional porous carbon foam base has a porosity of range of about 98.5% to about 61%.

6. The battery of claim 1 wherein the three-dimensional porous carbon foam base has a pore size of about 200 μm.

7. The battery of claim 1 wherein the three-dimensional porous carbon foam base has a pore size range of about 1 μm to about 100 μm.

8. The battery of claim 1 wherein the three-dimensional porous carbon foam base has a cell size from about 5 μm to about 5000 μm.

9. The battery of claim 1 wherein the three-dimensional porous carbon foam base has a density in a range of about 0.03 g/cm³ to about 0.6 g/cm³.

10. The battery of claim 1 wherein the three-dimensional porous carbon foam base has a compressive strength in a range of about 0.2 MPa to about 60 MPa.

11. The battery of claim 1 wherein the three-dimensional porous carbon foam base has a resistivity of about 1.4×10⁻³ ohms/cm.

12. The battery of claim 1 wherein the three-dimensional porous carbon foam base has a Li+ capacity of about 160 mAh/g.

13. The battery of claim 1 further comprising a layer of polyphenyl oxide formed over the electrolyte layer.

14. The battery of claim 13 wherein the layer of polyphenyl oxide has a layer thickness of about 20 nm to about 200 nm.

15. The battery of claim 1 wherein the anode current collector is in electrical communication with the three-dimensional porous carbon foam base.

16. The battery of claim 1 further comprising a cathode layer disposed over the electrolyte layer.

17. The battery of claim 16 wherein the cathode layer comprises about 90 wt % LiCoO₂ nanoparticles, about 5 wt % aqueous binder and about 5 wt % carbon black.

18. The battery of claim 16 wherein the cathode current collector is in electrical communication with the cathode layer.

19. A method of making a three-dimensional battery comprising:
attaching an anode current collector to a region of a three-dimensional porous carbon foam base;
immersing the three-dimensional porous carbon foam base in an electrolyte to form an electrolyte layer over the three-dimensional porous carbon foam base;
forming a layer of polyphenyl oxide formed over the electrolyte layer using an electropolymerization process;
infiltrating the three-dimensional porous carbon foam base with a carbon slurry; and
attaching a cathode current collector to a second region of the three-dimensional porous carbon foam base.

20. The method of claim 19 wherein infiltrating comprises infiltrating the three-dimensional porous carbon foam base with about 90 wt % LiCoO₂ nanoparticles, about 5 wt % aqueous binder and about 5 wt % carbon black.

21. The method of claim 19, further comprising removing fluid from the three-dimensional porous carbon foam base to form a cathode layer over the polyphenyl oxide layer.

22. The method of claim 21, wherein attaching the cathode current collector to the second region of the three-dimensional porous carbon foam base comprises forming an electrically conductive path between the cathode current collector and the cathode layer.

23. The method of claim 19, wherein attaching an anode current collector to the region of the three-dimensional porous carbon foam base comprises forming an electrically conductive path between the anode current collector and the three-dimensional porous carbon foam base.

24. The method of claim 19, further comprising applying 60 second pulses of about 1.1 Volts to about 2.3 Volts vs. Ag/AgCl to form the layer of the polyphenyl oxide.

25. A method of making a three-dimensional battery comprising:
forming a three-dimensional base from a porous carbon foam having a predetermined geometric structure;
bonding an anode current collector to a region of the three-dimensional base;
forming a thin film layer of an electrolyte over the three-dimensional base;
forming a layer of polyphenyl oxide formed over the electrolyte layer;
infiltrating the three-dimensional base with a carbon slurry;
bonding the cathode current collector to a second region of the three-dimensional base.

26. The method of claim 25 wherein infiltrating comprises infiltrating the three-dimensional base with about 90 wt % LiCoO₂ nanoparticles, about 5 wt % aqueous binder and about 5 wt % carbon black.

27. The method of claim 25, further comprising applying 60 second pulses of about 1.1 Volts to about 2.3 Volts vs. Ag/AgCl to form the layer of the polyphenyl oxide.

28. The method of claim 25, further comprising removing fluid from the three-dimensional base to form a cathode layer over the polyphenyl oxide layer.

29. The method of claim 25, wherein bonding the cathode current collector to the second region of the three-dimensional base comprises forming an electrically conductive path between the cathode current collector and the cathode layer.

30. The method of claim 25, wherein bonding the anode current collector to the region of the three-dimensional base comprises forming an electrically conductive path between the anode current collector and the porous carbon foam of the three-dimensional base.

31. A three-dimensional battery comprising:
a three-dimensional porous anode foam base;
an anode current collector bonded to and in electrical communication with a first region of the base;
a separator layer disposed over the three-dimensional porous anode foam base; and
a cathode current collector bonded to and in electrical communication with a second region of the three-dimensional porous anode foam base.

32. The battery of claim 31 wherein the porous anode foam base comprises at least one of carbon, graphite, metallic lithium, a lithium alloy, aluminum, indium, tin, antimony, lead, silicon, lithium nitride, Li_{2.6}Co_{0.4}N, Li_{4.4}Si, or lithium titanate.

33. The method of claim 19 wherein the electrolyte is an acetonitrile-based electrolyte containing sodium phenoxide.

34. The method of claim 19 wherein the electrolyte is an acetonitrile-based electrolyte containing 0.05 M sodium phenoxide.

35. The method of claim 25 wherein forming a thin film layer of an electrolyte comprises placing the three-dimensional base bonded to the anode current collector in an acetonitrile-based electrolyte containing sodium phenoxide.

36. The method of claim 25 wherein forming a thin film layer of an electrolyte comprises placing the three-dimensional base bonded to the anode current collector in an acetonitrile-based electrolyte containing 0.05 M sodium phenoxide.
